(19) United States
(12) Patent Application Publication
(10) Pub. No.: US 2009/0144362 A1
(43) Pub. Date: Jun. 4, 2009

(54) SYSTEMS AND METHODS FOR PROVIDING DESKTOP MESSAGING AND END-USER PROFILING

(76) Inventors: Evan P. Richmond, Salt Lake City, UT (US); David E. Richmond, Salt Lake City, UT (US); Leonard R. Richmond, Salt Lake City, UT (US)

Correspondence Address: David B. Tingey, 1800 Eagle Gate Tower, 60 East South Temple, Salt Lake City, UT, 84145, US

(21) Appl. No.: 12/324,815

(22) Filed: Nov. 26, 2008

Related U.S. Application Data
(60) Provisional application No. 61/005,054, filed on Dec. 1, 2007.

(51) Int. Cl. G06F 15/16

(52) U.S. Cl. 709/203

(57) ABSTRACT

This application relates to systems and methods for providing desktop messaging and end-user profiling in a computer environment. Generally, implementation includes delivering imaged-based content (including advertisements) and/or multi-media messages to an end-user on a periodic basis. In some cases, the content is conveyed from a server software application to a client device via a conduit that does not use an Internet browser, RSS, XML, Javascripts, ActiveX, or an e-mail client. As the end-user reads or otherwise interacts with the software application on a client machine, software on the machine collects profile information from the end-user. This profile information is used to target additional content for the particular end-user.

### RELATED APPLICATIONS

This application claims priority to U.S. Provisional Patent Application Ser. No. 61/005,054 filed on Dec. 1, 2007 and entitled DESKTOP MESSAGING AND PROFILING SYSTEM, which is incorporated herein by reference.

### BACKGROUND OF THE INVENTION

1. Field of the Invention

The present invention relates to desktop messaging and profiling in a computer environment. In particular, embodiments of the present invention relate to systems and methods for providing desktop messaging and end-user profiling that are capable of delivering image-based content to an end-user and targeting the content to the end-user.

2. Background and Related Art

The advent of the Internet has allowed a great increase in the types of communication tools that are available via computers. For example, the Internet has made it possible for computer users to access the World Wide Web, e-mail, real simple syndication (“RSS feeds”), widgets, gadgets, voice over Internet protocols (“VOIP”), and many other computer communication tools. Some of the countless endeavors that have benefited from the Internet and these computer communication tools include the proliferation of news, information, entertainment, social networks, business, trade, and advertising.

With respect to advertising, the Internet has become a channel for many forms of advertising. Some examples of Internet advertising include pop-up ads, banner advertisements, cost-per-click ads, e-mail advertisements, spam, and the like. In some instances, Internet advertising has made it possible for advertisers to reach relatively large audiences across the world without paying for postage and paper.

Despite the many benefits associated with some forms of Internet advertising, such advertising methods have shortcomings. By way of example, while e-mail advertisements may be sent to a large number of people, only a portion of those e-mails are actually delivered to their intended recipient. Further, only a portion of the e-mails that actually arrive are opened. Moreover, of the e-mail advertisements that are opened, only a portion of them display the images and/or advertising as intended.

In another example, many computer users find a variety of forms of Internet advertising, such as spam, e-mail advertisements, pop-up ads, etc., to be annoying. In still another example, many forms of Internet advertising are used to convey spyware, viruses, key stroke loggers that steal information, widget platforms that provide an unauthenticated user with remote access to a computer, and other malicious “secret” software. To avoid these potentially annoying and dangerous advertisements, many users implement filters that block or modify Internet advertisements. For instance, many e-mail programs and Internet service providers are configured to strip images out of e-mails and to quarantine questionable correspondence.

In yet another example, many conventional forms of Internet advertising are targeted to a broad class of individuals. For instance, some forms of Internet advertising are displayed on web pages, regardless of the content of the page. In other instances, the advertisements are configured to be targeted to the content of the page. In both of these instances, however, the advertising may not be particular well targeted for a specific user. As a result, some such forms are only marginally effective.

Thus, while techniques currently exist that are used to advertise over the Internet, challenges still exist. Accordingly, it would be an improvement in the art to augment or even replace current techniques with other techniques.

### SUMMARY OF THE INVENTION

The present invention relates to desktop messaging and profiling in a computer environment. In particular, embodiments of the present invention relate to systems and methods for providing desktop messaging and end-user profiling that are capable of delivering image-based content to an end-user and targeting the content to the end-user.

Implementation of the present invention takes place in association with at least one profiling and tracking server, at least one update database, and at least one client machine. Generally, the client machine may comprise any suitable computer device, such as a personal computer, a notebook computer, a tablet computer, a personal digital assistant, a cellular telephone, or another hand-held device, a workstation, a minicomputer, a mainframe, a supercomputer, a multi-processor system, a network computer, a processor-based consumer electronic device, or the like. Additionally, the server may be connected to the client machine over any suitable network, such as the Internet or an intranet.

Generally, when an end-user installs or otherwise becomes a user of the desktop messaging and profiling software application, the software application creates and assigns a globally unique identifier (“GUID”) code to the user. The software application then delivers content, including advertisements, to the end-user on a substantially regular basis. This content is shown on the desktop environment of the client machine as a content display window. In some instances, this content display is automatically positioned as the top layer of the desktop environment over any and all applications running. As the end-user interacts with the content in the content display window, software on the client machine tracks the user's interactions and reports these actions to a database, such as a hosted profiling server database. The end-user's profile information and unique identity code are correlated and used to create a profile on that particular end-user. From this profile, the server software can serve, for retrieval by the client machine, specific updated content that is targeted to that particular end-user.

In some implementations, the content is image-based. In such implementations, the content that the end-user sees on the content display consists essentially of images. Indeed, where the content is image-based, even text is displayed as an image. Accordingly, the content is displayed on the client machine, as intended, and is not subject to formatting and rendering issues that can occur with text-based content, such as e-mail and web pages. In addition, image-based content is not searchable by many search engine applications, like GOOGLE DESKTOP®.

Where the content is image-based, the content display may display a single image or it may display multiple images as a composite. In fact, because less memory and download time may be required for a content display that comprises a composite of images, such composite images may be preferred in some instances.

The client software and the updating and profiling server software may communicate with each other in any suitable manner. In some instances, however, the client software and the server software communicate with each other through a conduit that does not use an Internet browser, an e-mail client, RSS, XML, ActiveX, Javascripts, and/or any other standardized Internet protocol. In such instances, the content will not be blocked, stripped, or distorted by an Internet service provider or an e-mail client.

In some instances, the client software and/or content is updated through the use of pull technology. In such instances, the updates may be performed in any suitable manner. In one example, the client software queries the server software on regular and adjustable intervals to see if an update is necessary.

In some cases, to ensure that the update files have not been tampered with or become corrupt during transfer, the client machine retrieves a configuration file from the server software. This configuration file may comprise any suitable information, including a report of the file size of the update file and/or a reported alpha-numeric signature that identifies the update file. After receiving this configuration file, the client machine may retrieve the actual update file. Nevertheless, before the client software deploys the updated file, the software checks the file size and/or reported alpha-numeric signature from the configuration file with the actual file size and alpha-numeric signature of the update file. If either the file size or the signature does not match, then the client software can dispose of the update file and start the process over.

As mentioned, in some instances, the software application collects profile information about the end-user and uses the profiling information to target content to the end-user. In such instances, the software application may gather information about the end-user in any manner that allows the end-user to retain anonymity. In one example, the end-user optionally inputs some biographical data, such as age, gender, birthday, anniversary, etc. In another example, client software tracks the content that is selected (e.g., clicked on) by the end-user, the number of times the content is selected, the content that is not selected, and the like.

Unlike many conventional Internet advertising applications, in some instances, the described software application does not place cookies, which are frequently deleted from client machines. Additionally, in some cases, the described software application only tracks interactions with the content display window and does not track Internet activity, e-mail activity, or activity with other files on the client machine.

While the methods and processes of the present invention have proven to be particularly useful in the area of advertising, those skilled in the art can appreciate that the methods and processes can be used in a variety of different applications and in a variety of different areas, including e-commerce, magazine or newspaper publishing, loyalty and incentive programs, training programs, etc. For instance, the software application may serve as a daily, digital, and dynamic magazine. Additionally, in some instances, the software application is used to create a community of end-users that share a common interest in the content.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention can be explained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use with embodiments of the present invention;

FIG. 2 illustrates a representative networking system that provides a suitable environment for use with embodiments of the present invention;

FIG. 3 illustrates a representative embodiment of a content display window of a desktop messaging and profiling software application;

FIG. 4 illustrates a representative embodiment of a layer of the content display window of FIG. 3, which is mapped for hyperlinks;

FIG. 5 illustrates a representative embodiment of a method for updating the described desktop messaging and profiling software application;

FIG. 6 illustrates a representative embodiment of a cursor-tracking grid for tracking end-user interactions with the content display window; and

FIG. 7 illustrates a representative embodiment of a method for targeting the update content for a particular end-user.

### DETAILED DESCRIPTION OF THE INVENTION

The present invention relates to desktop messaging and profiling in a computer environment. In particular, embodiments of the present invention relate to systems and methods for providing desktop messaging and end-user profiling that are capable of delivering image-based content to an end-user and targeting the content to the end-user.

In the disclosure and in the claims, the term “desktop environment” may refer to a graphical user interface that is based on the desktop metaphor, as is known in the art. In addition, the term “desktop” may be used to refer to a client computer device.

The following disclosure of the present invention is grouped into two subheadings, namely “Exemplary Operating Environment” and “Desktop Messaging and Profiling Software Application.” The utilization of the subheadings is for convenience of the reader only and is not to be construed as limiting in any sense.

### Exemplary Operating Environment

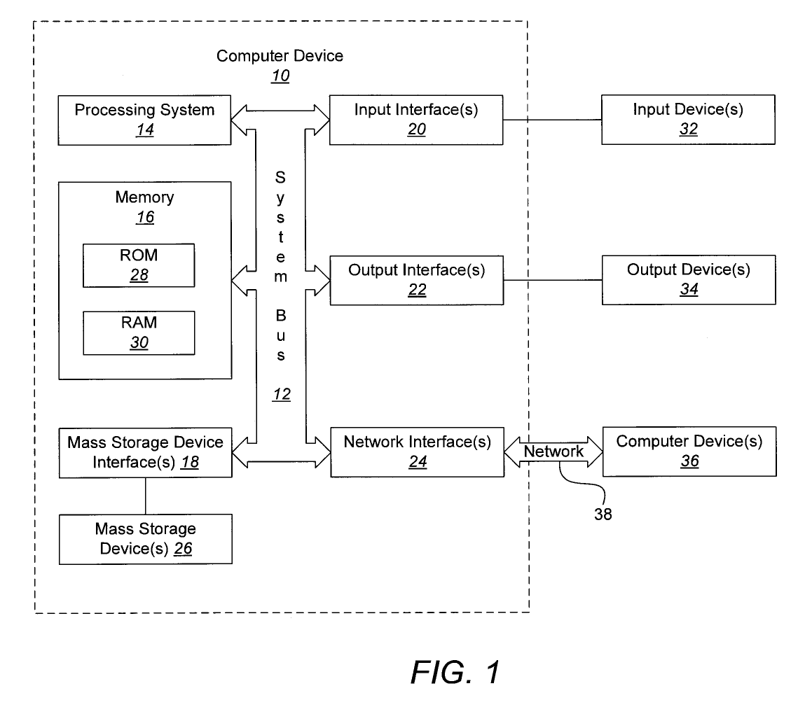

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a tablet computer, a personal digital assistant (“PDA”), a cellular telephone, or another hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor, and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a microphone, a joystick, a game pad, a satellite dish, a scanner, a camcorder, a digital camera, a tactile input device, and the like. Some examples of tactile input devices can include a keyboard and alternate input devices, such as a mouse, trackball, light pen, stylus, touchpad, touch-screen, or any other suitable pointing device. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a speaker, a printer, a visually perceptible output device (e.g., a monitor, display screen, or any other suitable visualization device), and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

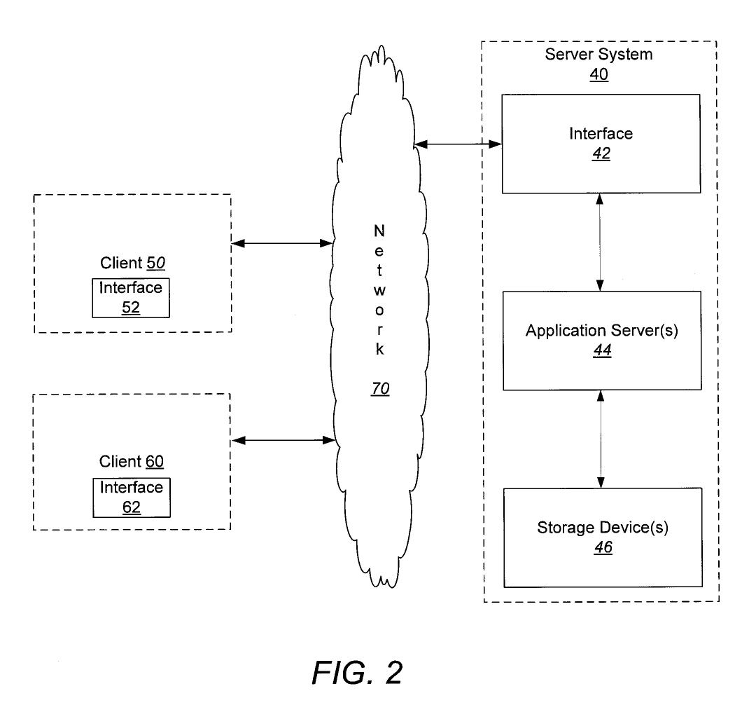

While those skilled in the art will appreciate that embodiments of the invention may be practiced in networked computing environments with many types of computer system configurations, FIG. 2 represents an embodiment of the present invention in a networked environment that includes client machines 50 and 60 connected to a server system 40 via a network 70. While FIG. 2 illustrates an embodiment that includes two client machines connected to the network, alternative embodiments include one client machine connected to a network or many client machines connected to a network. Moreover, embodiments in accordance with the present invention also include a multitude of clients throughout the world connected to a network, where the network is a wide area network, such as the Internet.

### Desktop Messaging and Profiling Software Application

Embodiments of the present invention relate to a desktop messaging and profiling that deliver content, which may comprise advertising and/or multi-media messages to an end-user on a substantially regular basis (e.g., monthly, weekly, daily, or another period of time or upon a triggered event). As the end-user chooses a content theme and reads or otherwise interacts with the content on the client machine (e.g., client machine 50), software on the client machine (“client software”) creates a profile from the end-user by tracking the end-user's input and interactions (“profile information”) with the software application, including content that the end-user views and/or selects (e.g., clicks on). In some embodiments, the client software reports the profile information to a profiling and tracking database application on the server (“server software”). From this profile information, the server software creates an end-user profile. The server software then uses the end-user profile to generate, for retrieval by the client machine, a content database—including advertising—that is specific for that particular end-user. Accordingly, the described software application is capable of creating highly-targeted content and/or advertising campaigns for a particular end-user, while still allowing the end-user to retain anonymity.

In some embodiments, the software application shows a content display window on the desktop environment of a client device or machine. The content can serve many purposes. Indeed, in some instances, the content is interesting to the end-user and, thereby, captures the end-user's attention on a regular basis. The content may comprise any message, image, sound, video or information that allows the content to fulfill its intended purpose. By way of example, the content may comprise images, text, multi-media, documents, or other messages that relate to a subject of interest. Some examples of potential subjects of interest may include but are not limited to, weather, news, traffic, sports, hobbies, humor, facts, history, inspirational thoughts, trivia, hints, advice, quotes, training, reminders, scheduling, calendar events (e.g., the date, holidays, etc.), countdowns to an event (e.g., a wedding, birthday, etc.), days since the installation of the software application, etc. In order to entice the end-user to interact with the software application on a substantially regular basis, in some embodiments, the end-user or an administrator selects the theme or type of content. In such embodiments, the software application may update the content on a regular basis and, thereby, encourage the end-user to interact with the software application regularly.

The software application may display any form of content, including image-based content, text-based content, and/or multi-media content. For instance, the content display may show images along with text (e.g., MICROSOFT® Word Documents, etc.) and/or multi-media. However, because text-based content may not always appear and be rendered in the intended manner, in some embodiments, the content is image-based. As used herein, the term image-based content may refer to content that is visible to the end-user and, which consists solely of images. In such embodiments, the images may have any format that allows them to be displayed on the client machine as intended. By way of example, the images can comprise JPG's, GIF's, and/or PNG's.

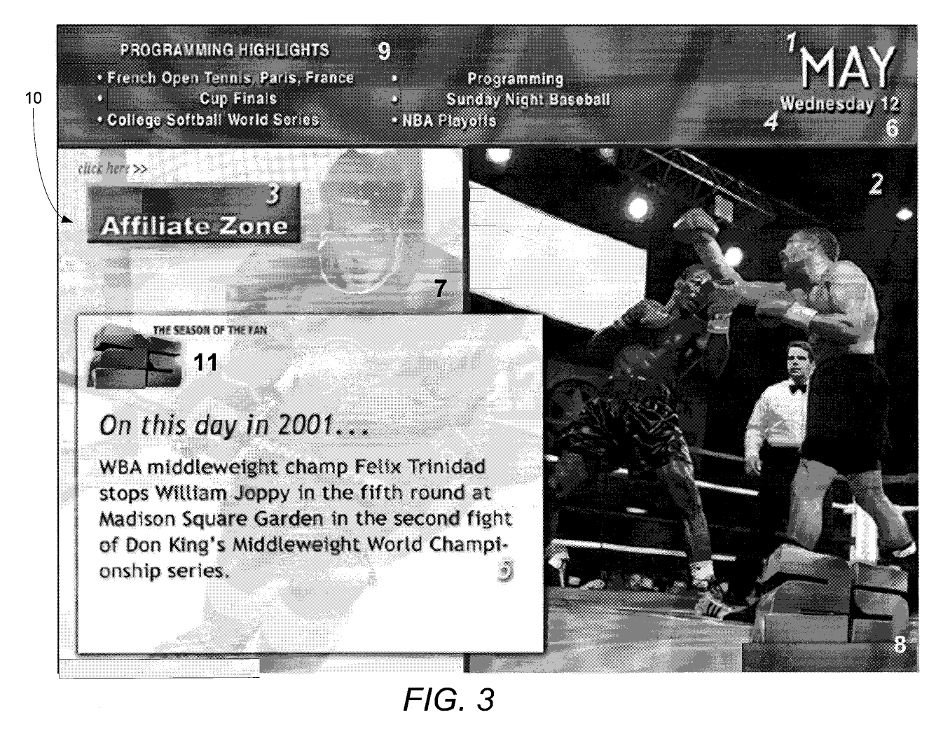

FIG. 3 illustrates a representative embodiment of a content display window 10 in which the content is image-based. In particular, FIG. 3 illustrates that content display window 10 may comprise a variety of image types (e.g., images 1 through 9). For instance, FIG. 3 shows that the content display 10 may comprise textual images (e.g., images 1, 4, and 5), photographs and wallpapers (e.g., 2 and 7), and any suitable form of advertising images (e.g., 3, 8, and 9). Of course, the skilled artisan will recognize that the content display may comprise many other types of images, in any suitable configuration.

Although, in some embodiments, the content is shown in the content display as a single image, in other embodiments, the content is displayed as a composite image comprising at least two images. In such embodiments, the software application may update one or more of the images while allowing the other images to remain unchanged. In other words, where the content display comprises a composite of images, the separate images that combine to form the whole content display may be updated independently as needed. As a result, a composite content display may require less memory to be stored on the client machine and allow for smaller downloads than a content display that consists of a single image.

Where the content display is presented on the client machine as a composite image, the content display may be presented and be updated in any suitable manner. FIG. 3, as previously mentioned, shows a representative embodiment in which the content display 10 comprises a composite of several images. In particular, FIG. 3 shows the composite display that comprises at least a first image 1 including the month “MAY,” a second image 2 comprising a photograph of a historical boxing event, a third image 3 displaying an advertiser's logo “Affiliate Zone,” a fourth image 4 showing the day of the week “Wednesday,” a fifth image 5 showing a sports history trivia fact, and a sixth image 6 showing the day of the month “12.” In FIG. 3, the first image 1 is updated only once for the entire month of May. Additionally, the second image 2 is updated on the anniversary of a historical boxing event and then left until the anniversary of another historical boxing event. Further, the third image 3 is only updated annually. Finally, in this example, the fourth 4, fifth 5, and sixth 6 images are updated daily.

In some embodiments in which the content is image-based, the content display may be mapped to include one or more electronic links or hyperlinks to a website or an application. As used herein, the terms “hyperlink” or “hyperlinks” may refer to any link, which the end-user may select to open an Internet site, a window, a file, or any other suitable software application (e.g., a multi-media application, a document viewer, etc.). In such embodiments where the content display is mapped for one or more hyperlinks, the cursor indicates the presence of a link (e.g., by turning into a hand) as the cursor passes over the mapped area. If the end-user selects the mapped area, the website or software application (e.g., FLASH PLAYER®, MP3 player, etc.) that is associated with the hyperlink is automatically initiated. In this manner, the end-user can access multi-media messages through the software application with a single click, even where the URL to the Internet site is lengthy.

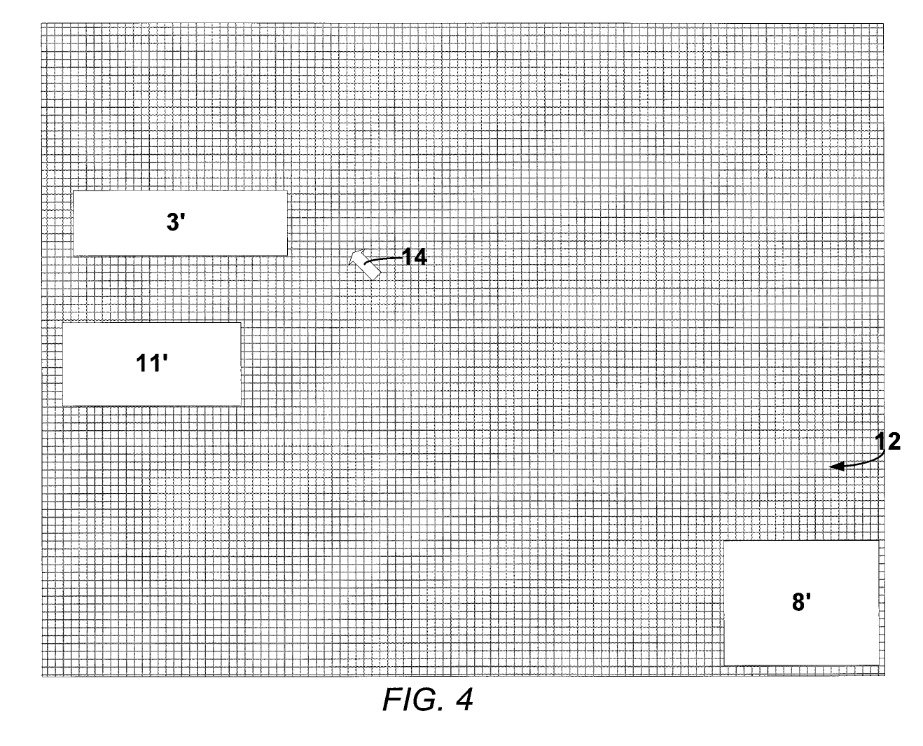

By way of example, FIG. 4 shows a representative embodiment of a layer 12 of the content display 10, which is not typically visible to the end-user, and which is mapped for the hyperlinks in FIG. 3. Accordingly, when the end-user moves the cursor 14 over the advertisements 3, 8, and/or 11 from FIG. 3, the cursor also passes over the corresponding mapped areas 3′, 8′, and/or 11′.

The content display can be shown on the client machine at virtually any time that the client machine is functioning. By way of example, upon installation of the software application, or at any time after, the end-user or an administrator may determine which days (e.g., business days, weekends, etc.), how many times a day, and at which time (e.g., hour) the content display will be shown on the client machine. Accordingly, in this example, the software application may automatically open on a regular basis. In another example, however, the software application can also be activated on demand through a desktop icon, which can be installed along with the software or at any other suitable time.

When the content display is shown on the desktop, the display may be shown in any suitable manner. In some embodiments, for instance, when the content display is opened, the content display is forced to be the top layer visible on the desktop environment. Accordingly, in such embodiments, the content display may overlap other windows that are open and, thereby, catch the end-user's attention.

Unlike conventional techniques, in some embodiments the described software application is designed so that content is delivered to the end-user through a conduit that does not use nor require an e-mail client, an Internet browser (e.g., FIREFOX®, INTERNET EXPLORER®, OPERA®, etc.), RSS feeds, HTML, XML, ActiveX, Javascripts, a Widget platform, or the like. Indeed, in such embodiments, the client software and the updating server software may communicate with each other in any manner that does not require the use of an e-mail client, an Internet browser, RSS feeds, HTML, XML, ActiveX, Javascripts, a widget platform, and/or another standardized Internet protocol. For simplicity, a conduit that does not require an Internet browser, e-mail client, RSS feeds, HTML, XML, ActiveX, Javascripts, or a Widget platform to transfer content is referred to herein as communication conduit. Where the client software and the server software communicate with each other through the communication conduit, the conduit may function in any suitable manner. In one example, the client machine communicates with the server through a hypertext transfer protocol (“HTTP” or “HTTPS”) by initiating a request and establishing a transmission control protocol (“TCP”) connection to a particular port on a host (e.g., port 80).

Because, in at least some embodiments, the content is delivered to the end-user through the communication conduit, the content is not subject to being filtered, stripped, blocked, distorted, or otherwise be modified by an e-mail client, a spam blocker, an Internet service provider (“ISP”), or the like.

Additionally, because the software application is not accessible via an Internet browser, web-crawlers, or spiders, cannot crawl through the content displays to make their content available for monetization on Internet search sites. Similarly, because search engines, such as YAHOO® and GOOGLE® cannot crawl through the content displays, such search engines are not be able to place their advertising networks (e.g., DOUBLECLICK® and ADWORDS®) on the content displays. Thus, the communication conduit allows the software application to compete in fields that were not previously available to many Internet advertising providers.

Through the communication conduit, a content database on the client machine and/or the client software may be updated in any suitable manner. For instance, the updating could be performed through the use of push and/or pull technology. As used herein, the term “push technology” may refer to a method in which a centralized server pushes content to a plurality of client machines at approximately the same time. Additionally, as used herein, the term “pull technology” may refer to a method in which a client machine calls out to randomized servers at different times. Because push technology may allow multiple computers to be attacked (e.g., by hijacking software) at once, in some presently preferred embodiments, the described software application implements pull technology to download content.

The software application may update the content database on the client machine at any suitable time that a network connection (e.g., the Internet) is open between the client machine and the server. By way of example, the client machine may query the server software on a remote server on a regular basis to see if an update is necessary. For instance, the client machine may query the server software every 20 minutes, or as desired.

In some embodiments, the software application pre-downloads any content to the content database on the client machine in the background, transparent to the end-user. In other words, the software application can download content before the end-user is able to see or select the content. For instance, without requiring user action, the software application can download multi-media content, such as video, Flash, PDF's, POWERPOINT® presentations, MP3's, MICROSOFT WORD® documents, etc. so that the content is immediately available for display when the user selects (e.g., clicks on) a link to the content. Accordingly, unlike some conventional computer messaging and advertising applications, the described software application allows the end-user to click on a link to multi-media content and to experience the content (e.g., video, music, photographs, etc.) without waiting for buffering, streaming, downloading, and/or Internet traffic.

In some embodiments, to protect the content during transit between the server and the client device or machine (e.g., during updating), the software application implements one or more security measures. While the software application can implement any suitable security measure that ensures the content has not been tampered with or become corrupt, in some embodiments, before being retrieved from the server, each update file is assigned an alphanumeric signature that must be matched on the client machine before the content can be displayed as the content display on the client machine. In such embodiments, this alphanumeric signature changes with every update of content. Additionally, in such embodiments, the alphanumeric signature may have any suitable number of digits, including 6, 8, 10, 12, 13, or more. In another example, before an update file is retrieved from the server, each update file size is measured in bytes. In this example, before an update file can be displayed on the client device or machine, the client machine verifies that the size of the update file has not changed.

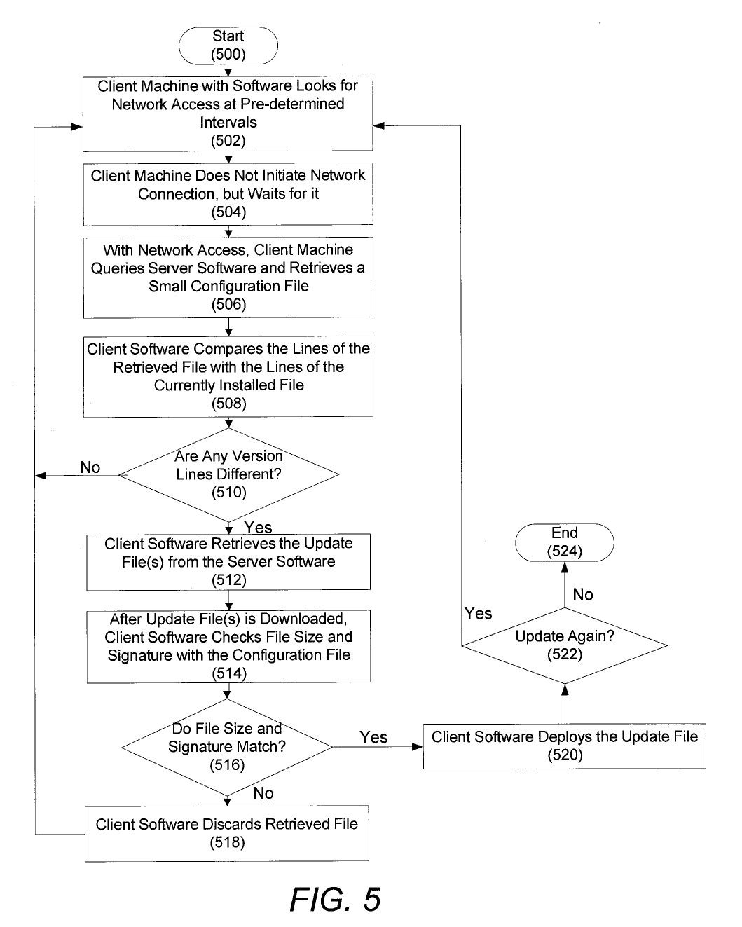

While the updating process may occur in any suitable manner, a representative embodiment of an updating process is shown in FIG. 5. Specifically, FIG. 5 illustrates that after the method begins at 500, the client machine with client software checks for network (e.g., Internet) access at previously determined intervals, as shown at box 502. At box 504, FIG. 5 shows that where the client machine is not constantly connected to the server via the Internet or another network (e.g., where the client machine uses a dial-up connection), instead of initiating access to the server, the client machine waits for it.

Once the client machine has access to the Internet or another network, FIG. 5, at box 506, shows the client machine queries the server software and retrieves a small configuration file, which may comprise a line of text for each potential update file, the update file name, a version number, an alphanumeric code, and/or the file size of the potential update file(s). In order to determine if the update is needed, box 508 shows that the client software compares the version line of the retrieved configuration file with the version line of the content currently being displayed.

At decision box 510, FIG. 5 shows that if none of the version lines between the configuration file and the currently displayed content vary, the method returns to 502, where the client machine checks for network access at the next determined interval. However, decision box 510 further shows that if any of the version lines of the configuration file and the content file that is current being displayed are different, the method proceeds to box 512. At box 512, FIG. 5 shows the method proceeds as the client machine and the client software retrieve the update file(s), which corresponds to the configuration file, from the updating server software.

After the update file has been downloaded to the client machine, decision box 516 shows that as the method continues, the client software compares the file size and the alpha-numeric signature of the update file to the file size and the alpha-numeric signature reported in the configuration file. Box 518 shows that if either the file size or the alpha-numeric signature is incorrect, the client software discards the retrieved update file. After the update file has been discarded, FIG. 5 shows the method continues by returning to box 502.

If both the file size and the alpha-numeric signature of the update file match the signature and file size reported in the configuration file, box 520 shows the update file or files are deployed. Following deployment, decision box 522 shows that the method can either continue by returning to box 502 for additional updates or end at box 524. It should be noted that while the method in FIG. 5 focuses on updating content, a similar method may be used to update software or any other component of the software application.

As previously mentioned, in some embodiments, the software application profiles and targets the end-user. Unlike some conventional computer messaging applications that track the end-user's keystrokes; place cookies; bundle adware, spyware, malware, or other “secret” software; and/or require the end-user to enter an e-mail address, name, telephone number, physical address, or other personal information that could be stolen or used against the end-user, the software application may collect profile information from the end-user without removing the end-user's privacy and/or anonymity.

In some embodiments, in order to track the end-user without requiring the end-user to reveal the e-mail address, name, or physical address, the client software assigns the end-user a unique identity code (e.g., a globally unique identification (“GUID”) or a universally unique identifier (“UUID”)). Not only can a unique identity code allow the software application to distinguish one end-user from another, the identity code can also allow the software application to send messages to and track the end-user, even if the end-user changes e-mail addresses. The unique identity code may be assigned to the end-user in any suitable manner or at any suitable time. In one example, the unique identity code is assigned to the end-user when the user sets up an account on the client software or installs the client software on the client machine.

Once the end-user is assigned a unique identity code, the client software may collect profile information from the client in any suitable manner. For instance, the client software can profile the end-user contextually, temporally, biographically, geographically, and/or behaviorally according to the end-user's interactions with the software application.

The software application can obtain profile information about the end-user in any suitable manner. In one example, the software application contextually profiles the end-user by determining the theme or genre of the content that was chosen to be displayed on the client machine over a period of time. For instance, according to the subject matter that the end-user selected during installation to be displayed on a regular basis, the software application could determine that the end-user had an interest in sports, news, business training, or any other subject. Continuing in this example, the software application can further contextually profile the end-user on an on-going basis by determining the theme or genre of the content that the end-user selects or does not select over a given period of time. For instance, if the end-user received daily content regarding sports trivia and chose golf trivia more than another sport trivia, the software application could identify the end-user's interest in golf.

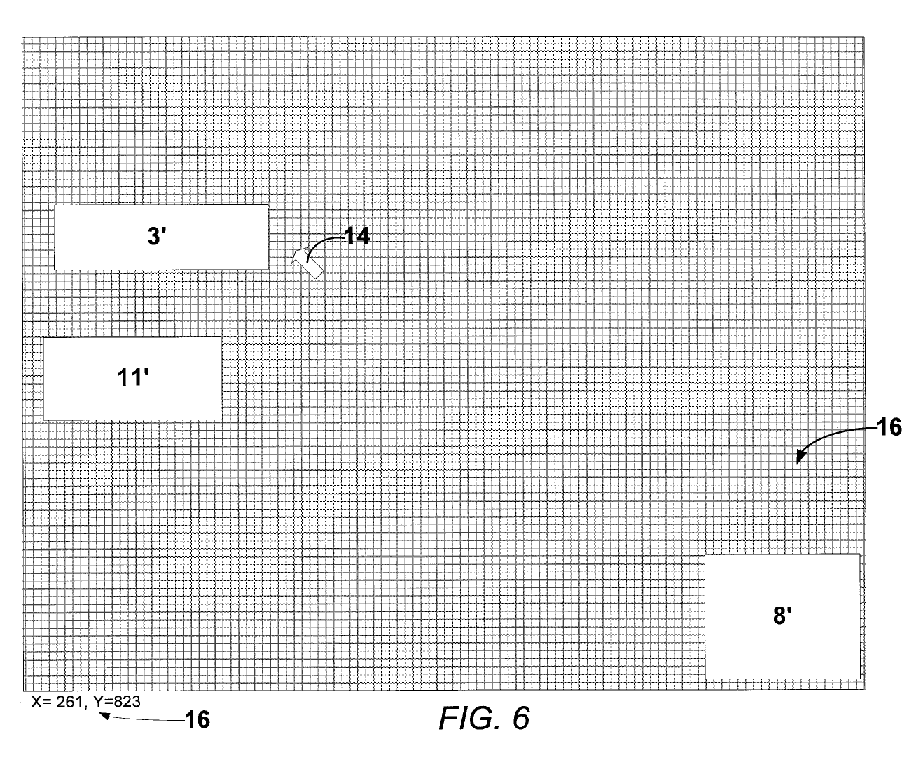

While the software application (e.g., the client software) may track the content that the end-user selects or does not select in any suitable manner, FIG. 6 shows that, in at least some embodiments, the content display comprises an unseen layer 16, which tracks actions taken by the cursor and occurrences of the content display. In this example, the client software can track any cursor interaction in any suitable manner, including through the use of X and Y coordinates 20.

In another example, the software application temporally profiles the end-user. In this example, the software application can gather any information relating to the time at which the user interacts with or views content through the software application. For instance, the software application may determine the time of day, week, month, or year when the end-user tends to view the content display, select content for display, make purchases, the amount of time it takes the client to make a purchase, the time until an event occurs (e.g., a sale), etc.

In still another example, the software application biographically profiles the end-user. In this example, the software application may gather any personal information from the end-user. For instance, the end-user may optionally provide end-user input, which states the age, sex, birthday, anniversary, or other basic and non-personal information.

In yet another example, the software application geographically profiles the end-user. In this example, the software application can collect any information relating to the geographic location of the end-user. In some instances, the end-user chooses to provide the software application with end-user's zip code, city, state, country, province, or other basic information relating to the location of the end-user. In other instances, the software application uses the IP address of the client machine to determine the machine's location (e.g., country, region, province, state, city, zip code, DMA zone, etc.).

In a final example, the software application behaviorally profiles the end-user. In this example, the software application may gather any information that relates to the user's behavior. For instance, the software application may gather information about type of purchases made, the timing of the purchases, personal preferences or interests that are entered as end-user input, etc.

In some embodiments, the client software reports the gathered profile information to a profiling server database, which is in communication with the updating server software. From this profile information, the server software can then serve, for retrieval by the client machine, specific content, that is matched and targeted for the particular end-user.

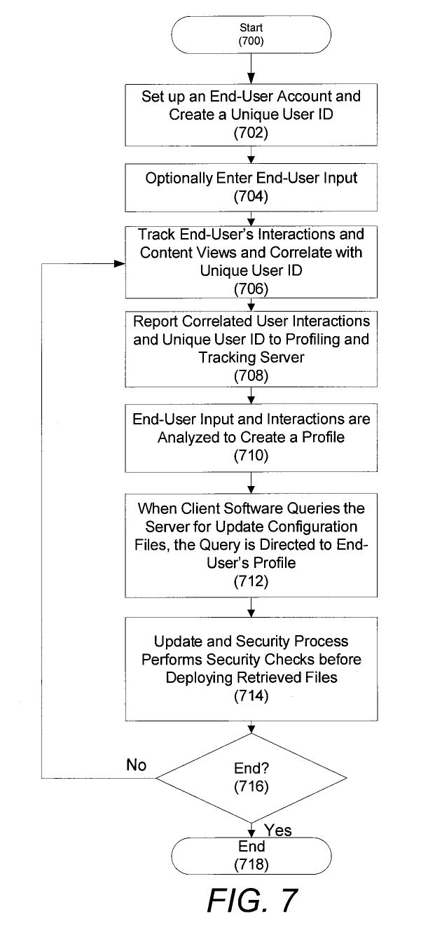

While the profiling and targeting process may occur in any manner that allows the end-user to retain anonymity and to use the communication conduit, FIG. 7 provides a representative embodiment of a method for profiling an end-user and using that profile to target content, including advertising, to the user. In particular, at box 702, FIG. 7 shows that after the method begins at 700, the client software assigns a unique identity code to the end-user. Next at box 704, FIG. 7 shows the method continues as the end-user optionally enters end-user input (e.g., zip code, gender, birth date, anniversary, and other non-identifying information), which is correlated with the unique identity code and sent to the profiling server database.

Box 706 shows that as the end-user interacts with the content display, the client software tracts the end-user's interactions and correlates the interactions with the unique identity code. Then, as shown at box 708, the client machine and client software send the gathered information and correlated unique identity code to the server database.

Box 710 shows that the end-user input, the end-user interactions, and any other gathered data are analyzed to create an end-user profile. Accordingly, when the client software queries the server for an update configuration file, as shown at box 712, the query is directed to the end-user's profile. As a result, the server makes available, for retrieval by the client machine, an update path that is targeted especially for that particular end-user.

Box 714 shows that this targeted content may then be tested for security purposes, as shown at 514 and 516 in FIG. 5, before the targeted content can be deployed. After the update files have been deployed, decision box 716 shows the method may be repeated, by returning to box 706, or ended by terminating the software application at 718. When the method returns to box 706, the software application continues to analyze the changing end-user profile to better target content and advertising for the end-user's contextual, temporal, geographical, biographical, and behavioral profile.

The software application can use the profile information to tailor content, including advertising, to a specific user in any manner. For instance, the software application may use the profile information to contextually, temporally, biographically, geographically, and/or behaviorally target content, including ads, to a particular end-user. While this targeting may take place in any suitable manner, a representative scenario of advertising targeting is provided to better explain the software application.

In this scenario, a sports-related website provides a link to download and install a sports-trivia-related version of the software application. Because the end-users who install the client software do so to be exposed to regular (e.g., daily) sports trivia, these end-users may have targeted themselves contextually as having an interest in sports. In this scenario, when the end-user installs the client software, the end-user may optionally input the end-user's gender, birth date, birth year, and/or anniversary.

As the scenario continues, as a woman from Austin, Tex., installs the sports-trivia-related software application, she indicates her birthday and that she has no anniversary. With this profile information, the software application could target the woman in a variety of ways. In one example, the software application could use the gathered profile information to geographically and temporally target the woman by displaying a discount to a local restaurant on her birthday. In another example, the software application could contextually, geographically, biographically, temporally, and behaviorally target the woman by displaying advertisements to a sports bar that is located near the University of Texas and which has a “Girl's Night Out” next Wednesday.

In another example, because the software application notices that woman only purchases products on the weekends, the application temporally and behaviorally targets her by placing product offerings on the weekends. In still another example, because the woman looks at baseball trivia more frequently and for a longer time period than football trivia, the software application contextually and behaviorally targets her by reducing or eliminating the amount of football trivia that is shown in the content display. In a final example, because the woman did not input an anniversary date, the software application biographically and behaviorally targets her by displaying advertisements for singles.

As shown above, the described software application may offer several benefits and advantages. For instance, because the software is permission based and does not place cookies or other “secret” software on the client machine, the end-user may feel comfortable using the application and passing it to friends. In another example, because the software application uses the communication conduit, the content displayed to the end-user is not subject to being stripped, blocked, or distorted by an e-mail or ISP filter. Similarly, because the application does not require an e-mail client, the application can continue to profile and provide content to the end-user if the end-user changes e-mail addresses.

In still another example, the software application's security features (e.g., verification of update file size and alpha-numeric code) ensure that the content has not been modified or corrupted during transfer. In still another example, where the content is image-based, the content can always be displayed as intended without reformatting that can occur with text-based ads. Additionally, where the content is imaged-based, the content may be in a format that cannot be crawled by a web-crawler or spider.

In yet another example, because the software application collects profile information with minimal end-user input, the application can provide highly-targeted content in a non-intimidating manner. In a final example, because the content display may be regularly opened and positioned as the top layer of the desktop environment over all and any running applications, the end-user is more likely to see the content than if it were sent by another means, such as e-mail.

In addition to the previously mentioned features, components, and capabilities, the described software application may include any other suitable element that allows it to provide the end-user with content and to target that content according to the end-user's profile. In one example, the software application includes a pass-along feature that allows the end-user to send the software application to a friend. In this example, the software application includes a feature that records who the end-user passed the application to, the number of times the end-user installs the application, etc. In still another example, the software application includes a search feature that allows the end-user to search for additional content of interest.

The present invention may be embodied in other specific forms without departing from its spirit or essential characteristics. The described embodiments and examples are all to be considered, in all respects, only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer program product for implementing within a computer system a method for providing a desktop messenger and profiling system, the computer program product comprising:
a computer readable medium for providing computer program code means utilized to implement the method, wherein the computer program code means is comprised of executable code for:
assigning a unique identity code to an end-user;
using a communication conduit to convey content from a server to a client machine;
displaying the content on the client machine;
tracking end-user profile information on the client machine;
correlating the profile information with the unique identity code to create an end-user profile; and
targeting updated content to the end-user based on the end-user profile.

2. The computer program product of claim 1, wherein the content comprises imaged-based content.

3. The computer program product of claim 2, wherein the image-based content is shown on the client computer in a content display window comprising a composite of images.

4. The computer program product of claim 2, wherein the image-based content is mapped for hyperlinks.

5. The computer program product of claim 1, further comprising updating the content through the use of a pull technology.

6. The computer program product of claim 5, wherein the updating comprises:
using the client machine to retrieve a configuration file comprising a reported file size and a reported alpha-numeric code of an update file;
retrieving the update file; and
comparing the reported file size and the reported alpha-numeric code with an actual file size and an actual alpha-numeric code of the update file.

7. The computer program product of claim 1, wherein the content is automatically displayed on the client machine as a content display window and as a top layer on a desktop environment, at a pre-determined time.

8. The computer program product of claim 6, wherein the updating process pre-downloads the content before allowing the end-user to select the content.

9. A computer program product for implementing within a computer system a method for providing a desktop messenger and profiling system, the computer program product comprising:
a computer readable medium for providing computer program code means utilized to implement the method, wherein the computer program code means is comprised of executable code for:
assigning a unique identity code to an end-user when an account is set up on a client machine;
using a communication conduit to convey image-based content from a server to the client machine;
displaying the image-based content on the client machine as a content display window;
using client software on the client machine to track end-user profile information on the client machine;
reporting the profile information to a server software application;
correlating the profile information with the unique identity code to create an end-user profile; and
making available, for retrieval by the client machine, update content that is targeted to the end-user based on the end-user profile.

10. The computer program product of claim 9, wherein the content display is automatically displayed on the client machine as a top window layer on a desktop environment, at a pre-determined time.

11. The computer program product of claim 9, further comprising updating the content, wherein the updating comprises:
using the client machine to retrieve a configuration file comprising a reported file size and a reported alpha-numeric code of an update file;
retrieving the update file; and
comparing the reported file size and the reported alpha-numeric code with an actual file size and an actual alpha-numeric code of the update file.

12. The computer program product of claim 9, wherein the image-based content is mapped for hyperlinks.

13. The computer program product of claim 9, wherein the content display window comprises a composite of image-based content.

14. The computer program product of claim 9, wherein the profile information is selected from contextual profile information, temporal profile information, behavioral profile information, biographical profile information, and geographical profile information.

15. A method for providing desktop messaging and end-user profiling in a computer environment, the method comprising:
assigning a unique identity code to an end-user;
using a communication conduit to convey content from a server to a client machine;
displaying the content on the client machine;
tracking end-user profile information on the client machine;
correlating the profile information with the unique identity code to create an end-user profile; and
targeting updated content to the end-user based on the end-user profile.

16. The method of claim 15, wherein the content comprises imaged-based content.

17. The method of claim 16, wherein the image-based content is shown on the client computer in a content display window comprising a composite of images.

18. The method of claim 16, wherein the image-based content is mapped for hyperlinks.

19. The method of claim 15, wherein the content is automatically displayed on the client machine as a content display window and as a top layer on a desktop environment, at a pre-determined time.

20. The method of claim 15, further comprising updating the content, wherein the updating comprises:
using the client machine to retrieve a configuration file comprising a reported file size and a reported alpha-numeric code of an update file;
retrieving the update file; and
comparing the reported file size and the reported alpha-numeric code with an actual file size and an actual alpha-numeric code of the update file.
